(19) United States
(12) Patent Application Publication
(10) Pub. No.: US 2025/0182639 A1
(43) Pub. Date: Jun. 5, 2025

(54) PERSONALIZED LEARNING AND ADAPTIVE SIMULATION ENGINE

(71) Applicant: PETE Inc., Orlando, FL (US)

(72) Inventors: Jacques Fu, Orlando, FL (US); Alex Damis, Orlando, FL (US); Luis Garcia, Orlando, FL (US)

(21) Appl. No.: 18/968,680

(22) Filed: Dec. 4, 2024

Related U.S. Application Data
(60) Provisional application No. 63/606,356, filed on Dec. 5, 2023.

(51) Int. Cl. G09B 5/06; G06N 20/00

(52) U.S. Cl. CPC G09B 5/06; G06N 20/00

(57) ABSTRACT

Systems and methods for developing personalized instructional content include a computing device using software modules which capture data about subjects, teachers, and learners, train artificial intelligence models based on the acquired data, use the artificial intelligence models to generate instructional content personalized to an instructor and/or learner based their input, compare the generated instructional content to vetted sources and correct errors, and cause the processor to output a personalized instructional course including the updated generated instructional materials in the format capable of display to an individual learner.

### CROSS-REFERENCE TO RELATED APPLICATION

This application claims priority to U.S. Provisional Patent Application No. 63/606,356 filed on Dec. 5, 2023, the entire content and disclosure of which is incorporated by reference in its entirety.

### BACKGROUND

The field of the disclosure relates generally to education, and, more specifically, to a system and method that generate personalized courses using artificial intelligence, instructional design best practices, and learning management systems (LMS).

Education is a cornerstone of our society where instructors pass on knowledge to students. Traditionally, instructors present materials in person to the students. Online or virtual education instruction have grown in popularity in recent years to facilitate remote or asynchronous learning. Typically, an instructor or an administrator uploads or otherwise makes accessible education materials in electronic form. For example, the instructor or administrator may upload a video of the instructor presenting a lesson and the students may watch the video at their own pace whenever they want. However, the education materials are typically static and do not provide interaction with the student. In addition, the instructor and student do not receive real time feedback on how the student is processing and learning the material.

### BRIEF DESCRIPTION

The disclosure is directed to personalized learning and adaptive simulation engine artificial intelligence models trained on instructor samples and educational data sets.

In one aspect, an educational computing system for developing personalized instructional content involves a data acquisition module for capturing data about subjects, teachers, and learners, a model training module which trains artificial intelligence models based on the acquired data, a dynamic course generator which employs the artificial intelligence models to generate instructional content personalized to an instructor and/or learner based their input, direction, and preferences, a content verifier that compares the generated instructional content against vetted information sources and corrects errors and/or omissions in the generated instructional content, a learning management system bridge which interfaces with third-party learning management system software to deliver the generated instructional content to a learner, an adaptive learning orchestrator which analyzes learner data and interaction with the system, and a personalization module that instructs the dynamic course generator to modify or prepare generated instructional content based on learner performance and preferences.

In another aspect, a computer-implemented method for generating and delivering personalized instructional content involves collecting data about subjects, instructors, and learners, developing a database of such data, training artificial intelligence models on the data, using the trained artificial intelligence models to generate instructional content, comparing the generated content to verified sources and correcting any errors, delivering the generated content to a learning management system, collecting learner input and interactions, and modifying or creating instructional materials in response to the learner's performance and preferences.

In another aspect, an educational computing device for generating personalized instructional content includes a system memory and a processor in communication with the system memory. The system memory includes a data acquisition module that causes the processor to collect instructional data associated with an instructor and translate the instructional data into a normalized computer-readable format. The system memory also includes a model training module that causes the processor to receive the instructional data in the selected format from the data acquisition module, extract multi-modal features from the data, and identify a pedagogical pattern from the multi-modal features extracted from the data. The pedagogical pattern is associated with the instructor. The system memory further includes a dynamic course generation module that causes the processor to employ one or more generative artificial intelligence models to generate instructional materials based on the pedagogical pattern associated with the instructor and translate the generated instructional materials into a format capable of display to an individual learner. The system memory also includes a content integrity verification module that causes the processor to collect verified information on the subject matter of the generated instruction material. The verified information includes information from one or more databases of vetted content. The content integrity verification module compares the verified information with the generated instruction materials, identifies differences between the verified information and the generated instruction materials, and modifies portions of the generated instruction materials which are inconsistent with the verified information such that the modified portions of the generated instruction materials are consistent with the verified information. The dynamic course generation module causes the processor to output a personalized instructional course including the updated generated instructional materials in the format capable of display to an individual learner.

In another aspect, a computer-implemented method for generating and delivering personalized instructional content is implemented by an educational computing device including a system memory and a processor in communication with the system memory. The computer-implemented method includes collecting via a data acquisition module instructional data from one or more data sources, processing via the data acquisition module, the instructional data into a normalized computer-readable format, storing the processed instructional data on an electronic data storage media, and developing, via a model training module, a pedagogical pattern associated with an instructor based on the stored instructional data. The computer-implemented method also includes employing via the dynamic course generator one or more generative artificial intelligence models to create instructional materials based on the pedagogical pattern associated with the instructor, comparing via a verifier the generated instructional materials against verified information sources, modifying, via the verifier, the generated instructional materials to align with the verified information based on the comparison of the generated instructional materials against verified information sources, and causing a processor to output a personalized instructional course including the generated instructional materials in a format capable of display to an individual learner.

### BRIEF DESCRIPTION OF THE DRAWINGS

FIG. 1 is a block diagram of an educational system.

FIG. 2 is a block diagram of an educational system.

FIG. 3A is a block diagram of steps performed by a personalized learning and adaptive simulation engine.

FIG. 3B is a block diagram of an implementation of a personalized learning and adaptive simulation engine.

FIG. 4 is a block diagram illustrating physical components (e.g., hardware) of a computing device with which aspects of the disclosure may be practiced.

FIG. 5 is a block diagram of system memory incorporating example aspects of a personalized learning and adaptive simulation engine.

FIG. 6 is a flowchart of an implementation of aspects of a personalized learning and adaptive simulation engine.

FIG. 7A is a flowchart of an implementation of aspects of a personalized learning and adaptive simulation engine.

FIG. 7B is a flowchart of an implementation of aspects of a personalized learning and adaptive simulation engine.

FIG. 8 is a block diagram showing the flow of information between components of a computing device 400 according to aspects of a personalized learning and adaptive simulation engine.

FIG. 9A is a block diagram showing the flow of information between multiple computing devices and components thereof according to aspects of a personalized learning and adaptive simulation engine.

FIG. 9B is a block diagram showing the flow of information between multiple computing devices and components thereof according to aspects of a personalized learning and adaptive simulation engine.

### DETAILED DESCRIPTION

As used herein, an element or step recited in the singular and preceded with the word “a” or “an” should be understood as not excluding plural elements or steps, unless such exclusion is explicitly recited. Furthermore, references to “example” or “one implementation” of the present disclosure are not intended to be interpreted as excluding the existence of additional implementations that also incorporate the recited features.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

The present disclosure provides an automated system and method for creating personalized instructional courses and dynamic skill simulations using artificial intelligence models. The system uses artificial intelligence models trained on samples of an instructor's audio, voice, and writing, in addition to large public and private data sets. The AI model is designed to generate comprehensive multi-modal course materials including but not limited to text, video, speech, diagrams, interactive assessments, and slides, all conforming to instructional design best practices and tailored to replicate an instructor's teaching style and adapt dynamically to individual student profiles. The instructor simply needs to provide a brief description or full outline of the desired course, which the system uses to generate the entire course content automatically. Unlike existing technologies, this system introduces adaptive AI-driven assessments or simulations where learners can engage in realistic, practice-based scenarios designed to build and assess specific skills in real-time. Reinforcement learning algorithms enable the system to adjust scenarios and feedback dynamically, targeting areas for improvement while maintaining a challenging yet supportive environment. A robust content integrity verification pipeline ensures accuracy and coherence across all formats. The system's seamless integration with Learning Management Systems (LMS) allows for scalable deployment of both instructional content and practice environments. By enabling automated creation of adaptive, instructor-aligned learning experiences and skill-building simulations, this disclosure addresses the growing need for personalized, practice-oriented education at scale.

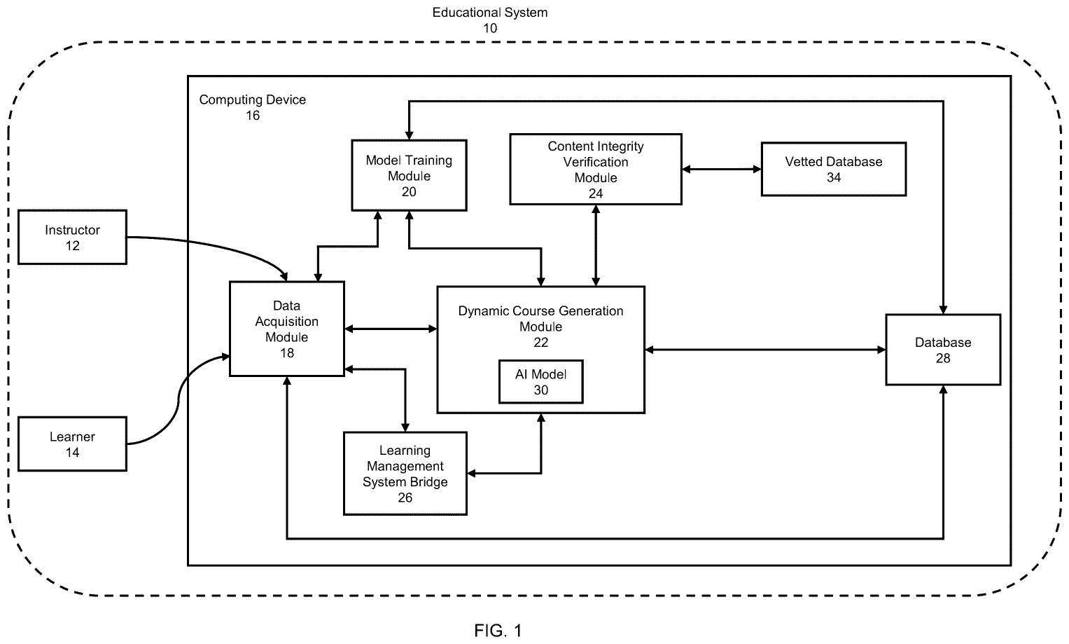

FIG. 1 is a block diagram of an educational system 10. The system 10 includes at least one instructor 12, at least one learner 14, at least one computing device 16, a data acquisition module 18, a model training module 20, a dynamic course generation module 22, a content integrity verification module 24, a learning management system (LMS) bridge 26, a database 28, at least one AI model 30, and a vetted database 34.

The instructor 12 refers to a person who interacts with the educational system 10 for the purpose of directing the educational system to produce an educational course or education content concerning a topic designated by the instructor. The instructor may also specify the course be created to align with quantitative or qualitative characteristics of the instructor or his or her pedagogical practices. The instructor interacts with the educational system 10 by interacting with the computing device 16, including by use of input/output devices as described further herein. Input from the instructor to the computing device is provided to the data acquisition module 18 for further use by the educational system and components thereof.

The learner 14 refers to a person who interacts with the educational system 10 for the purpose of participating in an educational course or receiving educational content from the system. In some implementations, the learner may specify or direct the system to produce a course or educational content with a specific topic or in a specific style preferred by the learner. The learner interacts with the educational system 10 by interacting with the computing device 16, including by use of input/output devices as described further herein. Input from the learner to the computing device is provided to the data acquisition module 18 for further use by the educational system and components thereof. In some implementations, the educational system may provide for output of educational content to the learner (not shown in FIG. 1).

The computing device 16 may comprise any electronic device capable of storing and processing data according to one or more instructions or algorithms. Example computing devices comprise laptop or desktop computers, smartphones, tablet computers, and cloud servers. Computing devices may comprise further hardware, firmware, and software components as disclosed herein.

The data acquisition module 18 comprises a set of software instructions that, when executed on the processor of a computing device 16, retrieves or receives data from one or more sources. Example sources from which the data acquisition module may receive or retrieve data include the instructor 12 or learner 14 (which may be facilitated through additional hardware of the computing device 16), database(s) 28, or from external computing devices such as remote servers hosting databases. In some implementations, the data acquisition module 18 further converts the received or retrieved data from a first format to a second format.

The model training module 20 comprises a set of software instructions that, when executed on the processor of a computing device 16, perform one or more processing steps on data received from other elements of the educational system.

The processing step(s) performed include, in some implementations: extracting facts about a subject from the provided data (for example, that Napoleon was emperor of France); extracting elements of instructional practices from the provided data (for example, that information is presented in visual rather than written format); extracting elements of an instructor's behavior from the provided data (for example, an instructor's tone of voice); synthesizing a series of facts into a topic (for example, assembling a topic regarding how rainbows are formed from a series of facts regarding optics, atmospheric conditions, and so forth); synthesizing a series of instructional practices into a pedagogical practice; and synthesizing a series of data points concerning an instructor's behavior into a pedagogical profile of the instructor (for example, assembling a personality profile regarding an instructor's practice in responding to questions from a series of discrete examples of the instructor's past actions).

The model training module 20 retrieves or receives data from the data acquisition module 18 or one or more database(s) 28. In some implementations, the model training module 20 transmits processed or synthesized data to the database 28 for storage.

The dynamic course generation module 22 comprises a set of software instructions that, when executed on the processor of a computing device 16, cause the processor to execute one or more generative artificial intelligence models to generate instructional content as described further herein. The dynamic course generation module 22 may retrieve or receive data from the data acquisition module 18, model training module 20, or one or more database(s) 28. In some implementations, the dynamic course generation module 22 transmits generated instructional content to the database 28 for storage.

The AI model 30 comprises a set of software instructions that, when executed on the processor of a computing device 16, generate text, image, video, audio, or other forms of content based on data input to the model and instructions provided to the model regarding the content to be created.

The content integrity verification module 24 comprises a set of software instructions that, when executed on the processor of a computing device 16, retrieve or receive generated instructional content from the dynamic course generation module 22. The content integrity verification module further retrieves or receives verified information from vetted database(s) 34 where the verified information corresponds to facts or data points contained in the generated instructional content.

The content integrity verification module further compares the generated instructional content to the verified information to identify inconsistencies between the generated instructional content and the verified information. If inconsistencies are identified, the content integrity verification module executes additional steps to correct inconsistencies in the generated instructional content as described herein. For example, the content integrity verification module extracts key points or facts from generated instructional content, and if a key point or fact is inconsistent with corresponding verified information, replaces the inconsistent fact in the generated instructional content with the verified fact. The content integrity module also removes or deletes key points or facts which have been identified as inconsistent from the generated instructional content, and then communicates an instruction to the dynamic course generation module 22 to generate additional generated instructional content to replace the removed or deleted content. The dynamic course generation module 22 then transmits the additional generated instructional content to the content integrity verification module to reperform the verification process.

The vetted database 34 refers to a form of non-transitory computer readable media containing stored vetted information. Vetted information means that the accuracy and truthfulness of the information has been reviewed and confirmed by at least one recognized source and has otherwise been previously examined for accuracy and truthfulness. In some implementations, the parameters of vetted information may be defined by the instructor 12. Vetted information is also be referred to as verified or trustworthy information. The content integrity module 24 retrieves data from the vetted database 34.

The database 28 refers to a form of non-transitory computer readable media capable of storing data. The database 28 may be accessed by, transmit information to, or receive information from, various aspects of the educational system 10, including the data acquisition module 18, model training module 20, dynamic course generation module 22, and further from hardware elements of the computing device 16 (not shown in FIG. 1).

The learning management system bridge 26 comprises a set of software instructions that, when executed on the processor of a computing device 16, receive data regarding formatting and other interface requirements from an external software application comprising a learning management system. In some implementations, the interface requirement data is received or retrieved from the data acquisition module 18. The learning management system bridge 26 receives generated instructional content from the dynamic course generation module 22 and compares the format of the generated instructional content against the interface requirement data. If the generated instructional content is not consistent with the interface requirements, the learning management system bridge may further execute one or more processing operations to convert the generated instructional content into a format consistent with the interface requirements.

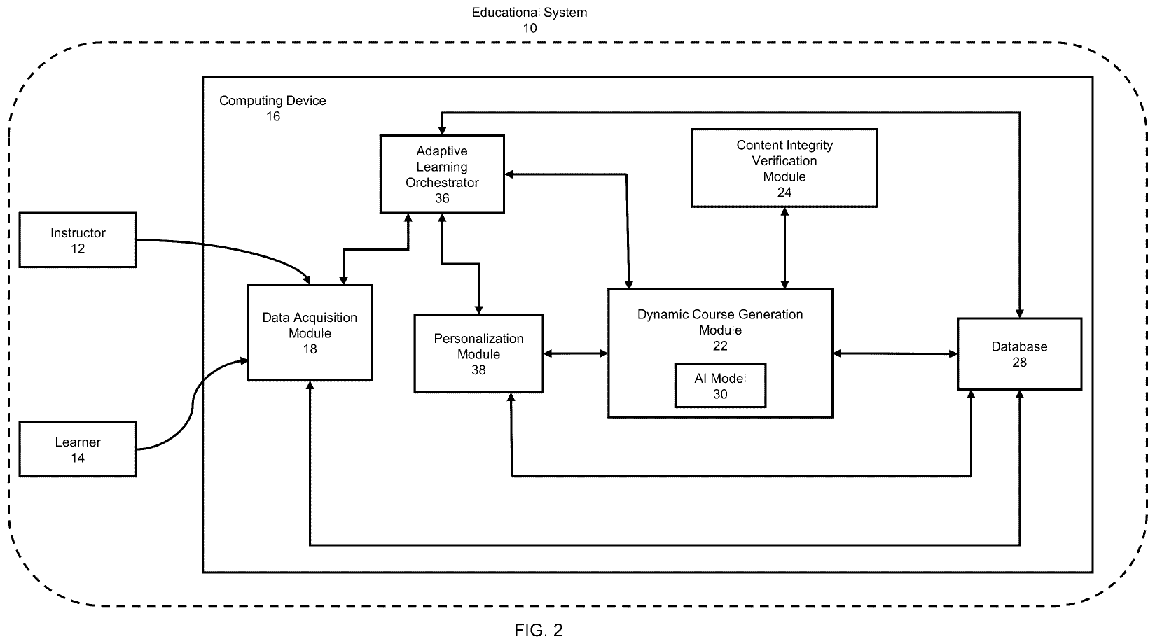

FIG. 2 is a block diagram of an educational system 10. The education system 10 may include elements described above including the instructor 12, learner 14, computing device 16, data acquisition module 18, dynamic course generation module 22, content integrity verification module 24, a database 28, and AI model 30, and may also contain other aspects described herein but not shown in FIG. 2. The educational system 10 further includes an adaptive learning orchestrator 36 and a personalization module 38.

The adaptive learning orchestrator 36 comprises a set of software instructions that, when executed on the processor of a computing device 16, receives or retrieves learner data from one or more sources which may include data acquisition module 18 or database 28. The adaptive learning orchestrator performs one or more processing steps on the learner data.

The processing step(s) performed include, in some implementations: extracting learner's knowledge about a subject from the learner data (for example, that the learner has basic Spanish-language skills); extracting learner performance data (for example, scores of a learner's responses to questions posed to the learner); extracting historic learner performance or completion data (for example, that the learner has completed a physics course with an average assessment score of 80%), extracting elements of learner practices or preferences from the provided data (for example, that the learner prefers content presented in video rather than written format); synthesizing a learner profile for a given topic or subject area (for example, assembling a profile that a learner has completed several basic courses in piano); synthesizing a series of learner practices or preferences associated with the learner; and synthesizing a series of data points concerning a learner's behavior into a learner profile of the learner. The adaptive learning orchestrator may transmit processed learner data to the database 28 for storage.

The personalization module 38 comprises a set of software instructions that, when executed on the processor of a computing device 16, facilitate interaction between the adaptive learning orchestrator 36 and dynamic course generation module 22 to personalize the generated educational content for the learner as described herein.

The personalization module 38 receives or retrieves learner data from the adaptive learning orchestrator 36 and generated educational content from the dynamic course generation module 22. The personalization module undertakes processing steps on the learner data, which include: predicting learner behavior based on the learner's profile (for example, anticipating questions the learner is likely to ask based on historic questions the learner has asked); and developing proposed course objectives for the learner based on the learner's profile (for example, suggesting the next level of a subject when the learner has demonstrated competence in the current level of the subject). The personalization module issues instructions to the dynamic course generation module 36, which may include instructions to: generate instructional content responsive to a predicted learner question; generate instructional content consistent with the developed proposed course objective; and modify previously generated instructional content to a format for which the learner has demonstrated a preference (for example, converting generated instructional content in written format into video format where the learner profile indicates the learner prefers to receive video content).

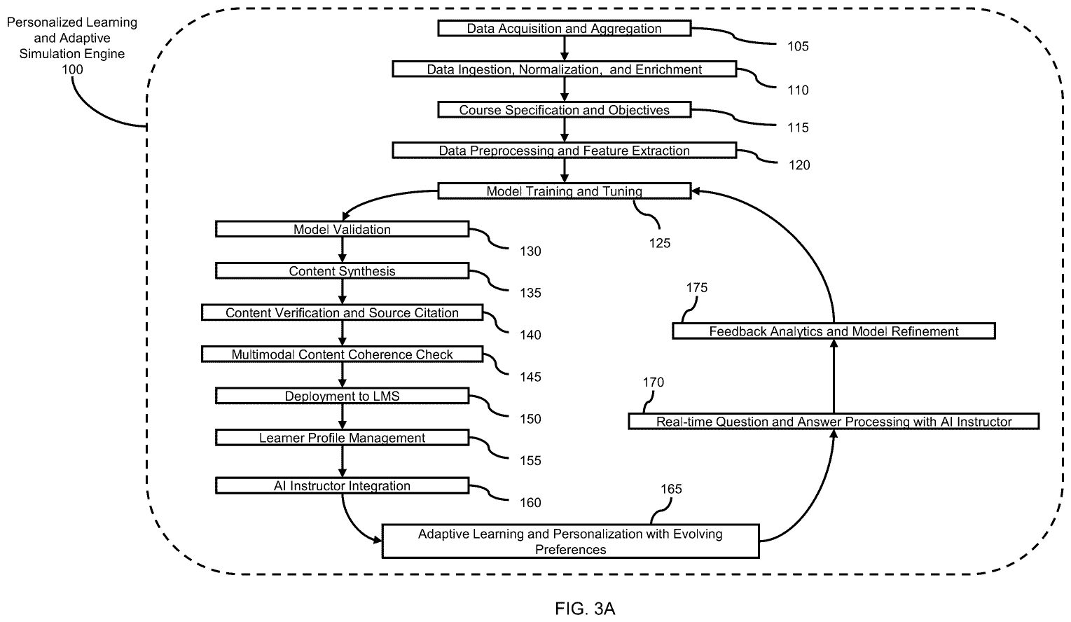

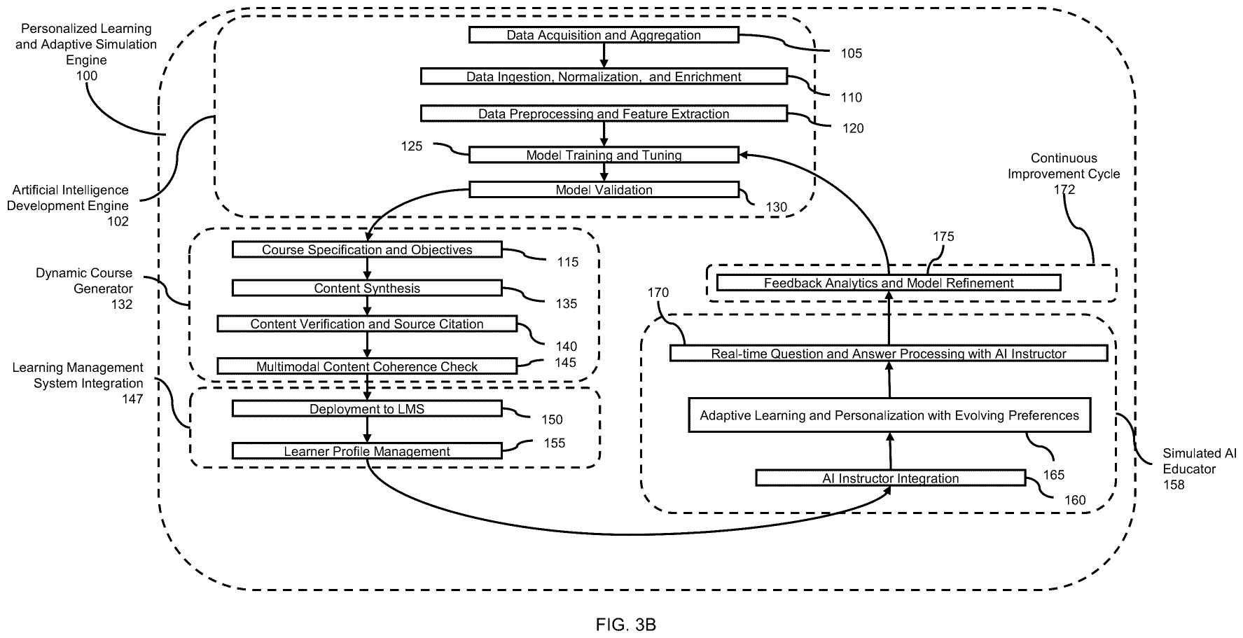

FIG. 3A is a block diagram of steps performed by a personalized learning and adaptive simulation engine 100. Referring to FIGS. 1, 2, and 3A, the personalized learning and adaptive simulation engine 100 may operate on or using components of the educational system 10 shown in FIG. 1.

For example, the personalized learning and adaptive simulation engine 100 includes data acquisition and aggregation 105 that is performed by the data acquisition module 18. For example, the data acquisition module 18 gathers a plurality of data elements, which may include information in text, video, audio, visual, or other formats. The information may be generalized in nature or may be selected for specific subject matter. The data may be drawn from one or more of a plurality of sources including instructor-submitted work samples, external or internal content databases, or other educational content. Data acquisition module 18 retrieves data using one or more practices including targeted queries and web crawling/scraping. This data and content is referred to broadly as “instructional data.”

The personalized learning and adaptive simulation engine 100 includes data ingestion, normalization and enrichment 110 that is performed by the data acquisition module 18. For example, the data acquisition module 18 ingests, normalizes, and enriches the data from various formats.

The data acquisition module normalizes data by performing one or more processing steps on the data, which may include: converting data from a first storage format to a second storage format; deletion or rejection of duplicative data; comparing the ingested data against data stored in one or more databases and rejecting duplicative data; and/or storing each data element in a single unique location within a database.

The data acquisition module enriches data by performing one or more processing steps on the data, which may include: ranking ingested data by quality and rejecting data of lower quality/fidelity, converting data from a first storage format to a second storage format where the second storage format has greater readability, utility, interoperability, or other desirable characteristics when compared to the first format; identifying gaps or missing elements within ingested data and/or one or more databases (for example, missing data on a particular educational topic), directing retrieval of data responsive to the identified gaps; identifying a lack of instructional data on a given topic in a defined format or structure (i.e., a lack of video content sources concerning a topic), and/or directing retrieval of data on a defined topic in the identified format.

The personalized learning and adaptive simulation engine 100 includes course specification and objectives 115 that is performed by the instructor 12, the learner 14, and/or the dynamic course generation module 22. The instructor 12, the learner 14, and/or the dynamic course generation module 22 define the course's desired structure, learning outcomes, and objectives. For example, the instructor 12 or the learner 14 inputs, using the computing device 16, information relating to the course, such as a course syllabus and/or a learning objective, and the computing device 16 provides the inputted information from the instructor and/or learner to the dynamic course generation module 22. The dynamic course generation module 22 extracts course parameters from the inputted information and generates the course's desired structure, learning outcomes, and objectives based on the inputted information. In some examples, the dynamic course generation module 22 employs one or more artificial intelligence (AI) models to extract the course parameters and/or generate the course information based on the extracted course parameters.

In some implementations, the course specification and objectives 115 are directed by the instructor 12. For example, the instructor 12 directs the system 10 to create an introductory calculus course based on the instructor's particular style and modeled on the instructor's existing materials.

In other implementations, the course specification and objectives 115 are directed by the individual learner 14. For example, the learner 14 directs the system to prepare a course based on a desired learning objective such as learning the basics of playing guitar. In still other implementations, the individual learner directs the system 10 to prepare a course on a subject and based on a specified instructor. For example, the individual learner may direct the system to prepare a course on how to play guitar using Eric Clapton as the basis for the instruction.

The personalized learning and adaptive simulation engine 100 includes data preprocessing and feature extraction 120 performed by the data acquisition module 18. For example, the data acquisition module 18 further refines the data and extracts salient features for modeling.

The personalized learning and adaptive simulation engine 100 includes model training and tuning 125 performed by the model training module 20. The model training module 20 selects, tunes, and trains the AI models using the datasets prepared by the data acquisition module, the dynamic course generation module 22, and/or data from one or more database(s) 28. Training refers generally to the process of providing data to the AI model, examining the results, comparing the results to desired results, and altering the model parameters or providing additional data in response to the comparison. Model training processes known in the art or later developed may be used.

The personalized learning and adaptive simulation engine 100 includes model validation 130 performed by the content integrity verification module 24. The content integrity verification module 24 verifies and assesses the trained model's performance against known benchmarks.

The personalized learning and adaptive simulation engine 100 includes content synthesis 135 via generative models employing the AI models 30. The AI models 30 generate course materials based on the course specification and objectives 115 and the model training and tuning 125. The content synthesis 135 may comprise employing one or more generative artificial models 30 to create text, images or graphics, audio, video, or other content, or combinations of any two or more content formats, corresponding to the course specification and objectives.

The personalized learning and adaptive simulation engine 100 includes content verification and source citation 140 performed by the content integrity verification module 24. The content integrity verification module 24 verifies generated content against trusted databases to ensure accuracy and reliability. Trusted databases include vetted databases 34. For example, the content verification and source citation 140 includes adding relevant citations to generated materials, identifying discrepancies or inconsistencies between generated content and verified information, and/or modifying the generated content to correct inconsistencies.

Content verification and source citation 140 acts as a method to reduce or eliminate the presence of incorrect, inaccurate, or misleading information that may be generated by the AI model 30 as part of the content synthesis 135. By reducing or eliminating the presence of incorrect, inaccurate, or misleading information in the generated materials, the personalized learning and adaptive simulation engine 100 reduces or eliminates the presence of “hallucinations” that occur in content output by existing generative artificial intelligence systems, thereby making the outputs of the personalized learning and adaptive simulation engine suitable for use in education where accuracy and veracity of information is critical.

The personalized learning and adaptive simulation engine 100 includes multimodal content coherence check 145 via the content integrity verification module 24. The content integrity verification module 24 verifies that content generated across different modes is coherent and consistent, for example confirming that the same key points or facts presented in a first content format such as text are consistent with the key points or facts presented in a second content format such as video. In conjunction with the content verification and source citation 140, the multimodal content coherence check 145 reduces or eliminates the presence of incorrect, inaccurate, or misleading information in the materials output from the personalized learning and adaptive simulation engine and improves the suitability of such outputs for use in educational settings.

The personalized learning and adaptive simulation engine 100 includes deployment to LMS 150 via the learning management system bridge 26. The learning management system bridge 26 integrates the generated and verified instructional content into a Learning Management System. Learning management systems may comprise any number of third-party software applications for the tracking and management of student educational performance and progress, having different interface requirements. The deployment to LMS 150 and the learning management system bridge 26 permit the personalized learning and adaptive simulation engine 100 to interact with a variety of these third-party software applications, thus providing for increased versatility of the personalized learning and adaptive simulation engine and content generated thereby.

The personalized learning and adaptive simulation engine 100 includes learner profile management 155 via the learner 14, data acquisition module 18, and adaptive learning orchestrator 36. This process manages individual student profiles, tracking their learning habits, strengths, and areas for improvement. Learner 14 inputs data into a computing device 16, and the learner data input is processed by the data acquisition module 18. The data acquisition module may also ingest learner data based on the learner's interaction with educational content, for example test scores or natural language queries input by the learner 14. The data acquisition module 18 transmits the ingested learner data to database 28 for storage. The data acquisition module 18 transmits the learner data to the adaptive learning orchestrator 36 for processing and development of a learner profile. The adaptive learning orchestrator 36 transmits the processed data and learner profile to the database 28 for storage.

The personalized learning and adaptive simulation engine 100 includes AI instructor integration 160. An AI instructor is incorporated for real-time student engagement and support. The AI instructor may be based on an instructor selected by the learner 14 and/or the instructor 12 that directed the course. The AI instructor replicates or embodies quantitative or qualitative aspects of one or more human instructors. The AI instructor presents in one or more forms including text, audio or text-to-speech, visual simulation (including through the use of virtual-reality or augmented-reality visualization), or other formats perceptible to a human. For example, an AI instructor for a painting class could present via a projection on virtual reality headset hardware as a three-dimensional visual avatar of Bob Ross with accompanying vocals rendered via text-to-speech mirroring the voice tone, speech pattern, and vocal pacing of Bob Ross.

The personalized learning and adaptive simulation engine 100 includes adaptive learning & personalization with evolving preferences 165 performed by the dynamic course generation module 22, adaptive learning orchestrator 36, and personalization module 38. The dynamic course generation module 22 adjusts the content and the AI Instructor's approach based on instructions received from the personalization module 38. The personalization module develops instructions based on the learner's evolving preferences received from the adaptive learning orchestrator 36 as part of the learner profile management 155.

The personalized learning and adaptive simulation engine 100 includes real-time question and answer (Q&A) processing with AI instructor 170 via the learner 14, data acquisition module 18, dynamic course generation module 22, adaptive learning orchestrator 36, and personalization module 38. The learner 14 inputs a question via the input hardware of the computing device 16. The input question is transmitted to the data acquisition module 18 and the adaptive learning orchestrator 36 as learner data. The adaptive learning orchestrator 36 transmits the input question as learner data to the personalization module 38. The personalization module 38 instructs the dynamic course generation module 22 to generate instructional content responsive to the input question, and the dynamic course generation module 22 employs the AI model 30 to generate instructional content responsive to the instruction. The AI Instructor offers real-time answers and elaborations, enhancing learning by the learner 14.

The personalized learning and adaptive simulation engine 100 includes feedback analytics and model refinement 175. The system 10 refines the AI models and content based on feedback and analytics.

For example, course specification and objectives 115 has instructor fix metrics for demonstrating learner mastery of a subject or topic. A metric for demonstrating mastery is defined by the instructor as the learner scoring at least a 70% on a traditional assessment such as a test. Content synthesis 135 involves the dynamic course generation module 22 employing an AI model to develop a set of multiple choice questions on the subject matter of the generated instructional content. The learner takes the test by interacting with the input/output devices of a computing device implementing the educational system. The learner's answers are scored.

In one example, feedback analytics and model refinement 175 via adaptive learning orchestrator 36 notes the questions the learner answered incorrectly and extracts the key points or facts to which the incorrectly answered questions relate. Feedback analytics and model refinement 175 via adaptive learning orchestrator 36 and personalization module 38 prepare instructions to the dynamic course generation module 22 to generate supplemental generated instructional materials covering the key points or facts related to the missed questions. The system presents these materials to the learner to reinforce the topics on which the learner missed questions.

In another example, feedback analytics and model refinement 175 via adaptive learning orchestrator 36 compares the learner's performance to prior learner performance (which may be stored as part of learner profile management 115). Feedback analytics and model refinement 175 identifies that the learner performs better on assessments taken after consuming generated instructional content in video format when compared to assessments taken after consuming generated instructional content in text format. Feedback analytics and model refinement 175 via adaptive learning orchestrator 36 identifies this as learner data associated with the learner and incorporates this into the learner's learner profile. Based on this change to the learner's learner profile, future generated instructional materials are generated in video rather than other formats to improve learner absorption and retention of the content.

In still another example, feedback analytics and model refinement 175 synthesizes a plurality of learner profiles and compares the synthesized result to an individual learner's learner profile. Feedback analytics and model refinement 175 determines the learner's learner profile has similarities to other learner profiles that suggest the individual learner will be more responsive to a teaching methodology that involves frequent shorter assessments (i.e., unit quizzes) compared to a teaching methodology that involves only a single comprehensive assessment (i.e., a single final course exam).

In still another example, feedback analytics and model refinement 175 identifies via data acquisition module 18 and adaptive learning orchestrator 36 a question about a subject that has been asked by multiple learners, i.e., that a key point or fact is missing in the generated instructional content received by such learners on that topic. Feedback analytics via adaptive learning orchestrator 36 and personalization module 38 prepare instructions to the dynamic course generation module 22 to generate supplemental generated instructional materials covering the key points or facts identified as missing from the content previously provided to learners.

FIG. 3B is a block diagram of an implementation of a personalized learning and adaptive simulation engine 100.

In some implementations, a personalized learning and adaptive simulation engine 100 generally comprises an artificial intelligence (AI) development engine 102, a dynamic course generator 132, a learning management system (LMS) integration 148, a simulated AI educator 158, and a continuous improvement cycle 172.

The AI model development engine 102 generally encapsulates the series of systematic procedures comprising the data acquisition and aggregation 105, data ingestion, normalization, and enrichment 110, data preprocessing and feature extraction 120, model training and tuning 125, and model validation 130.

With reference to FIGS. 1-3B, the AI model development 102 comprises a series of steps which include, gathering or receiving instructional data via the data acquisition module 18 converting via the data acquisition module 18 diverse formats of data into a standardized format, ensuring enriched datasets, extracting via the model training module 20 salient features instrumental for model training, and facilitating via the model training module 20 the selection, fine-tuning, and assessment of AI models.

The dynamic course generator generally encapsulates the series of systematic procedures comprising the course specification and objectives 115, content synthesis 135, content verification and source citation 140, and multimodal content coherence check 145.

With reference to FIGS. 1-3B, the dynamic course generator 132 comprises a series of steps which includes defining via the course specification and objectives 115 (based on input from instructor 12 and/or learner 14) the desired structure and objectives for one or more items of instructional content, generating via the dynamic course generator 22 and AI model 30 diverse educational materials, ensuring via the content integrity verification module 24 that AI-generated content undergoes rigorous verification against vetted databases, embedding in the generated instructional content via the content integrity verification module 24 appropriate source citations, and ascertaining via the multimodal content coherence check 145 that the generated instructional content offers a unified learning narrative across varied modes, ensuring content fidelity, coherence, and integrity.

The simulated AI educator 158 generally encapsulates the series of systematic procedures comprising AI instructor integration 160, adaptive learning and personalization with evolving preferences 165, and real-time question and answer processing with AI instructor 170.

With reference to FIGS. 1-3B, the simulated AI educator comprises a series of steps which includes introducing via the model training module 20 and dynamic course generation module 22 an artificial intelligence persona capable of real-time pedagogical interactions, equipping via the data acquisition module 18, dynamic course generation module 22, adaptive learning orchestrator 36, and personalization module 38 the artificial intelligence persona to provide immediate elucidations in the form of exposition, interrogatory, and personalized recommendations ensuring enhanced student engagement. This simulated AI educator operates in tandem with the continuous improvement cycle, harnessing feedback analytics to refine its instructional methodologies and insights.

The simulated AI educator further comprises a series of steps including interacting with the adaptive learning orchestrator 36 and student profile management 155 to capture and manage insights about a learner's learning habits, strengths, interests, existing knowledge, and areas of growth and tailoring or modifying via the adaptive learning orchestrator 36, personalization module 38, and dynamic course generation module 22 the learning content and methodologies, ensuring an optimized, individualized learning trajectory for each student.

### EXAMPLES

### LMS Integration Bridge

An LMS Integration Bridge is designed for seamless integration. The LMS integration bridge employs the Deployment to LMS process, facilitating the incorporation of generated, verified, and personalized educational content into a Learning Management System, priming it for student access and engagement.

### Continuous Improvement Cycle:

Acting as an iterative feedback mechanism, a continuous improvement cycle employs the Feedback Analytics & Model Refinement process. By systematically capturing feedback and leveraging system-generated analytics, this process channels insights back into the AI Model Development Engine, ensuring iterative refinement of AI models, methodologies, and content, perpetuating a cycle of continuous improvement. The continuous improvement cycle responds to learner performance to reinforce subjects or facts the learner has not demonstrated mastery of, fills in gaps where learner(s) ask additional questions, adjusts the form and delivery of content or teaching methodologies to respond to learner skills, preferences, strengths, or weaknesses.

### AI Model Development Engine

The AI Model Development Engine is an intricate subsystem purposed to craft high-fidelity replications of an instructor's unique pedagogical attributes across textual, vocal, and visual modalities. This engine harnesses a sophisticated data acquisition framework that interfaces with an array of data repositories. Educational content is culled from public data sources such as open academic repositories, educational forums, and digital libraries. Concurrently, a provision is made for instructors to directly upload their proprietary instructional materials, accommodating both structured formats, such as curriculum outlines or lecture notes, and unstructured formats like free-form annotations or impromptu recordings.

In some implementations, following data acquisition, the collated data undergoes rigorous categorization, distinguishing between public and proprietary sources, and further classifying based on structure. Dedicated normalization routines ensure uniformity across this diversified dataset. For example, while unstructured instructor notes might be semantically analyzed to extract key topics, structured datasets might be mapped to standardized curriculum structures. Furthermore, an enrichment process augments this data, meticulously distinguishing between nuanced rhetorical patterns, voice modulations, or specific physical gestures exhibited by the instructor.

In some implementations, feature extraction processes are employed post-enrichment. Audio inputs are subjected to spectral analysis, segregating voice tones and inflections. Video materials are processed frame-by-frame, leveraging tools like optical flow and pose estimation to capture the essence of the instructor's gestures and facial expressions. Textual data, drawn from both public sources and instructor contributions, undergoes deep natural language processing. This phase distills the pedagogical essence, capturing both broad educational contexts and the unique stylistic elements inherent to the instructor's delivery.

In some implementations, the multi-modal features extracted serve as the foundation for advanced model training. Harnessing architectures that support multi-task learning, the system seamlessly integrates insights from public educational data with proprietary instructor content. Transformer-based frameworks, lauded for their expertise in language modeling, adjust to the intricacies of diverse instructional content. They learn from broader educational paradigms and also the specific idiosyncrasies an instructor imparts. Complementing this, convolutional structures, often in tandem with recurrent networks, focus their learning on the auditory and visual nuances.

In some implementations, rigorous validation mechanisms are employed post-training. Ensuring the authenticity of the AI representation, models are challenged with unfamiliar instructional content, probing their capability to faithfully emulate the instructor's style across novel scenarios. Quantitative metrics tailored to each modality—be it textual coherence, auditory alignment, or visual mimicry—offer a granular assessment of the model's performance, ensuring a genuine, high-fidelity replication of the instructor's educational style.

### Dynamic Course Generator

In some implementations, the Dynamic Course Generator (DCG) serves as a computational module specifically tailored for the synthesis of pedagogical content. At the onset, the DCG interfaces with a user-friendly input mechanism, allowing instructors or course designers to clearly define the objectives, topics, and desired structure of the course. This input is crucial as it establishes the foundational framework upon which content will be generated. The DCG leverages pre-trained AI models, which have been conditioned on a diverse array of educational materials as well as specific samples from an instructor, to generate instructional content with high fidelity to the desired course specifications. A distinguishing feature of this generator is its ability to emulate the unique teaching style and mannerisms of a specific instructor, enhancing the authenticity and personal touch of the generated content.

In some implementations, upon receiving course objectives, the DCG strategically interrogates its internal AI models to source relevant content from its vast database. Utilizing advanced search algorithms, it identifies segments of information that align with the stipulated course objectives. The selected segments serve as raw material, which is then processed, restructured, and refined by the generative capabilities of the DCG to produce the final instructional content.

In some implementations, the DCG employs Generative Adversarial Networks (GANs) or Variational Autoencoders (VAEs) for content generation. The generative models within the DCG are trained on a vast corpus of educational content, ranging from textbooks to online lectures. This broad training data is enriched with specific samples from the instructor, including voice recordings, written content, and video footage, to capture the instructor's nuances. Advanced algorithms within the DCG analyze and extract features from these instructor-specific samples, ensuring that generated content not only adheres to the defined educational objectives but also mirrors the distinctive teaching characteristics of the instructor.

In some implementations, a multimodal approach is adopted by the DCG to produce content in various formats, including text, audio, video, and interactive assessments. A series of specialized sub-modules within the DCG are responsible for each modality. For instance, a text generator may use transformer-based models, like BERT or GPT variants, to produce written content. Simultaneously, a voice synthesis sub-module might employ models such as WaveNet or Tacotron to generate voiceovers that closely resemble the instructor's voice. For video content, algorithms that can superimpose the synthesized voice onto lip-synced video footages of the instructor might be utilized, ensuring a cohesive audio-visual experience.

In some implementations, the DCG integrates a dynamic template system, allowing for the structured presentation of generated content. These templates can range from slide presentations to interactive e-learning modules. Upon generating content, the DCG strategically populates these templates based on the course's defined structure, ensuring a logical flow and segmentation of topics. The populated templates not only ensure organization but also provide a consistent and professional aesthetic to the course materials.

In some implementations, the DCG is equipped with a real-time feedback mechanism that communicates with other system components. As content is generated, this mechanism facilitates instant reviews, allowing for immediate refinements. This iterative process ensures that the content produced aligns with both the educational benchmarks set by the system and the unique teaching attributes of the instructor.

In some implementations, the Content Integrity Verifier (CIV) operates as a multi-faceted system designed to ensure the fidelity, accuracy, and coherence of the AI-generated content. At its core, the CIV employs advanced algorithms to cross-reference generated content against trusted databases, authoritative references, and canonical educational sources. This cross-referencing ensures that the synthesized content aligns with established knowledge bases and avoids the propagation of misleading or incorrect information.

In some implementations, the CIV integrates a modular architecture wherein specialized sub-modules are dedicated to different content modalities. For instance, a Textual Integrity Sub-module might be adept at verifying written materials, employing techniques such as semantic analysis and topic modeling to ensure content validity. Simultaneously, a Multimedia Coherence Sub-module could analyze video, audio, or graphical elements to ensure that they are consistent with the instructor's provided samples and maintain instructional design principles.

In some implementations, the system taps into machine learning classifiers trained on vast sets of educational content. These classifiers are tuned to recognize patterns or structures typically seen in erroneous or off-topic material. By doing so, the CIV can flag potential anomalies or deviations in the AI-generated content for further review or automatic correction based on a confidence score threshold.

In some implementations, the verifier incorporates Natural Language Processing (NLP) techniques to assess content's syntactical and semantical structures. This NLP integration ensures that not only is the information factually accurate but also that it's presented in a logical and coherent manner, aligning closely with the instructor's linguistic style and nuances.

In some implementations, a feedback mechanism is embedded within the CIV, allowing for real-time adjustments based on user interactions. For instance, if multiple students query or express confusion about a particular content segment, the CIV can flag this segment for review. Concurrently, this feedback can be channeled into the AI Model Development Engine, ensuring that the model's future content generations are improved based on these insights.

In some implementations, the CIV has an integrated Source Citation Assistant that employs advanced algorithms to detect claims or statements requiring citations. Post detection, it retrieves the most appropriate references from a curated database, embedding them within the content to bolster credibility and traceability.

### Simulated AI Educator

In some implementations, the Simulated AI Educator is conceptualized as an advanced AI-driven pedagogical entity, crafted to emulate not just the voice and style, but also the instructional methodologies favored by a specific instructor. As instructors in the real world often employ Socratic questioning to stimulate critical thinking, the AI Educator is designed to simulate this by posing probing questions to learners, nudging them to think deeply and critically. This emulation is achieved by a meticulous training regimen wherein the AI model ingests and learns from numerous instructor samples, including their pedagogical strategies, lecture delivery, and feedback mechanisms.

In some implementations, leveraging deep learning techniques like transformer-based architectures, the AI Educator is endowed with the capability to replicate teaching practices such as ‘chunking’. Drawing inspiration from how instructors break down complex topics into manageable ‘chunks’ or segments for easier comprehension, the AI system can autonomously segment dense material into digestible portions, interspersing them with real-world examples or relatable analogies, akin to an experienced instructor.

In some implementations, real-time interactivity, reminiscent of classroom ‘active learning’ techniques, is facilitated. Emulating instructors who deploy think-pair-share activities, the AI Educator might pause a lesson and prompt learners to reflect on a topic, discuss with peers if in a group setting, or even draft a quick summary, before proceeding. This interactive mode is made possible through advanced Natural Language Processing (NLP) techniques, allowing the system to not only present content but also engage in meaningful dialogue, answer queries, and provide timely feedback, much like a tutor in a tutorial session. The AI educator can also leverage computer vision technology to detect active intentions such as raising a hand or passive intentions such as lack of focus or emotional sentiment related to the current content.

In some implementations, just as instructors employ differentiated instruction to cater to the varied learning styles of students, the AI Educator is embedded with a dynamic adaptive mechanism. Drawing insights from the Adaptive Learning Orchestrator, the AI Educator discerns the preferred learning modality of a student—be it visual, auditory, kinesthetic, or reading/writing. Armed with this knowledge, it can then adjust its instructional delivery, perhaps rendering complex concepts as infographics for visual learners, offering podcast-style explanations for auditory learners.

In some implementations, the AI Educator channels the ethos of ‘formative assessment’, a staple in contemporary pedagogy. Mirroring instructors who intersperse their lessons with mini-quizzes, polls, or reflective questions to gauge understanding, the AI system too can autonomously introduce periodic assessments. Feedback from these is instantaneously processed, enabling the system to recalibrate subsequent instruction, ensuring that areas of confusion or misconception are immediately addressed. Assessments can also take on the form of tailored labs and scenarios targeting specific areas in the learning path of the student and thereby increasing the velocity of learning through repetitive practice.

In some implementations, the system design incorporates substantive safeguards to mitigate risks pertaining to learner privacy and algorithmic biases. Comprehensive data encryption, access control lists, and consent protocols are implemented to ensure learner data remains secure and its usage strictly conforms to the permissions explicitly granted.

In some implementations, the Adaptive Learning Orchestrator acts as an intelligent mechanism to tailor educational content to individual learners, optimizing the learning experience by adjusting to each student's pace, proficiency, and preferences. This orchestrator employs advanced machine learning techniques, predominantly reinforcement learning, to adaptively modulate the learning path in real-time.

In some implementations, upon initiation of a course module, the orchestrator begins by assessing the learner's baseline knowledge, interests, and preferences using diagnostic assessments or pre-tests. Data from these assessments, combined with historical data related to the learner's past performances and interactions, is processed and stored in the Student Profile Management system. This dynamic profile is vital in mapping the learner's trajectory and serves as an input for the adaptive learning algorithms.

In some implementations, the core of the orchestrator utilizes a Reinforcement Learning (RL) model. This RL model interacts with the learning environment (comprising the student and the content) and makes decisions on content delivery based on the student's performance and engagement metrics. The student's interactions, such as quiz scores, time spent on modules, and frequency of interactions with the AI instructor, serve as rewards or penalties for the RL agent, guiding it to refine its decisions. Over time, the RL model learns an optimal policy to deliver content, ensuring that the student maintains a state of productive struggle, which is crucial for effective learning.

In some implementations, to account for evolving student preferences and the dynamic nature of learning, the orchestrator continually updates the learner's profile. This is achieved through the continuous monitoring of student interactions and feedback, as well as their performance metrics. Factors such as changes in learning pace, shifts in content preferences, or the introduction of new learning objectives are automatically detected and incorporated, allowing the orchestrator to recalibrate the learning path accordingly.

In some implementations, the orchestrator interfaces seamlessly with other system components, particularly the Dynamic Course Generator and the Simulated AI Educator. The AI Educator can leverage content curated and personalized by the orchestrator for real-time clarifications, thus simulating a more holistic and interactive learning environment. The orchestrator ensures that the student's learning experience is not only tailored to their current proficiency and preferences but is also dynamic enough to adapt to their evolving needs, resulting in a personalized and effective learning journey.

In some implementations, the Adaptive Learning Orchestrator is designed based on the theory of Constructivism, wherein learners actively construct knowledge by integrating new information with prior knowledge and experiences. To facilitate this constructive integration, the orchestrator continually assesses the learner's conceptual framework using pre-tests, allowing it to accurately map new concepts to the learner's existing cognitive structures. Leveraging Piaget's concepts of assimilation and accommodation, the orchestrator presents new information that the learner can assimilate into current mental models. When assessments indicate dissonance, suggestive of unfamiliar concepts, the orchestrator triggers accommodative scaffolds, helping the learner reconstitute mental models to integrate these new ideas.

### LMS Integration Bridge

In some implementations, the LMS Integration Bridge serves as a sophisticated middleware framework, meticulously designed to interface the generated course content with existing Learning Management Systems. This bridge operates on modular architecture principles, wherein it can be agnostically tailored to integrate with a diverse range of LMS platforms, be they proprietary, open-source, or custom-built.

In some implementations, a robust API (Application Programming Interface) integration layer is employed within the LMS Integration Bridge. This layer facilitates seamless data transfer and content synchronization, ensuring that course materials, inclusive of multimedia elements, quizzes, assignments, and other educational resources, are accurately relayed and represented within the target LMS. The API layer uses standard protocols like REST or GraphQL, paired with secure authentication and authorization methods such as OAuth or JWT, ensuring not only fluid data exchange but also the security of the transmitted content. The integration bridge can also be delivered via a “no code” mechanism and allows users to install a plugin through various LMS marketplaces without technical resources.

In some implementations, the bridge incorporates an advanced content transformation engine. Recognizing the potential disparities in content representation formats between the Dynamic Course Generator and various LMS platforms, this engine dynamically transforms course materials into LMS-compatible formats. It leverages a combination of XSLT, JSON transformation templates, and proprietary algorithms to reshape course materials, ensuring they adhere to SCORM, xAPI, or other prevalent e-learning standards, thereby guaranteeing consistent representation and interactivity within the LMS environment including monitoring and reporting of student progress and outcomes.

In some implementations, the LMS Integration Bridge possesses an adaptive error-handling mechanism. In scenarios where discrepancies, data mismatches, or integration errors arise, the mechanism is designed to capture such anomalies, generate descriptive error logs, and in select instances, autonomously rectify commonly recognized issues. Furthermore, it offers real-time notifications to system administrators or designated personnel, ensuring timely interventions when necessary.

In some implementations, scalability and performance optimization is a paramount concern of the LMS Integration Bridge. It employs distributed processing techniques, load balancers, and caching mechanisms to handle high volumes of course content deployment requests, ensuring uninterrupted LMS integration irrespective of demand surges or system load.

### Continuous Improvement Cycle

In some implementations, the Continuous Improvement Cycle commences when a learner interacts with the generated course. As the learner navigates through the course materials, metrics pertaining to their engagement, understanding, and performance are systematically captured. Such metrics may encompass the time spent on specific modules, response times to quizzes, frequency of interaction with the AI instructor, areas of repeated review, and accuracy rates on assessments. These metrics are stored and processed in a dedicated analytics repository tailored to accommodate time-series data, ensuring granularity in the learner's journey analysis.

In some implementations, advanced machine learning techniques, such as clustering and anomaly detection, are deployed on the aggregated data to identify patterns and deviations in learner behavior. By discerning these patterns, the system can flag modules or content sections where learners commonly experience difficulties, or conversely, areas that may be too simplistic and not challenging enough. Natural Language Processing (NLP) can be employed to semantically analyze feedback provided by the learner, allowing for a deeper understanding of content reception, clarity, and relevance from a qualitative standpoint.

In some implementations, the feedback garnered from these analyses interfaces with the AI Model Development Engine. A set of reinforcement learning algorithms can be triggered, aiming to optimize the course generation parameters based on actual learner outcomes and feedback. For instance, if a particular topic consistently registers low comprehension scores, the model may recalibrate to incorporate alternative teaching methods, more examples, or different instructional modalities for that topic in subsequent iterations.

In some implementations, the Simulated AI Educator is also informed by the insights derived from the Continuous Improvement Cycle. By understanding areas where learners frequently seek clarification or additional information, the AI educator can preemptively adapt its instructional strategy. This may involve offering supplemental materials, suggesting further readings, or even altering its mode of interaction, such as transitioning from a text-based dialogue to a visual representation or vice versa.

In some implementations, periodic feedback loops are established with the original instructor. Detailed reports, encapsulating the aforementioned analyses, are shared with the instructor, offering them insights into the efficacy of the AI-generated content and its alignment with their pedagogical intent. Based on this, the instructor can provide further samples, instructions, or nuances to better refine the AI model's understanding and generation capabilities. This symbiotic relationship between the instructor, the learner, and the AI-powered system ensures a perpetually evolving and optimizing learning ecosystem.

The proposed system encompasses an integrated suite of client applications, which include both native mobile applications and web-based applications operable within a web browser. These client applications interface with server-side applications through a network of Application Programming Interfaces (APIs). The server-side applications are hosted on a multi-tenant, cloud-based infrastructure, designed for optimal scalability and reliability.

Users interact with the system primarily through these client applications, enabling them to upload various assets such as voice samples, writing samples, or specific course requirements. This upload process can be conducted either directly through the client applications or via the APIs, facilitating integration with third-party solutions. Other end users will consume content through their client applications in the form of visual and audio content and will provide additional input via web cameras and microphone access for real-time interactivity.

The server-side applications house business logic and are equipped with numerous endpoints available via API that the client applications and LMS can use for storage and functional processing related to the personalized learning features. These are crucial for the execution of several core functions: the management and creation of course materials, the administration of user profiles, and the meticulous tracking of student performance.

Central to the system's operational efficiency is the employment of a relational database. This database is specifically structured to support and manage a diverse array of objects. These objects are critical for the generation of course materials, comprehensive user management, effective content management, diligent assessment processes, and thorough analytics.

To further enhance system performance, the training of language models, along with other machine-learning processes, is conducted on distinct servers and storage systems. This is a deliberate architectural choice, designed to segregate these intensive processes from the primary production systems. Such segregation is instrumental in minimizing bottlenecks within the production environment, thereby mitigating any adverse impacts on the overall user experience. The models trained in this environment are deployed to servers that can be accessed by the API.

In order to protect the privacy of each user's data, proprietary source data and sensitive materials used in the generation of courses will be stored in an isolated fashion in both vector and cloud storage and will not be used to train the global model without the user's explicit consent.

Moreover, the system utilizes advanced containerization and orchestration tools, such as Docker and Kubernetes. These tools are essential for the efficient management of the system's microservices architecture, ensuring that each microservice is deployed, scaled, and operated in a controlled and streamlined manner. Application logic will be continuously tested and deployed to the containers without downtime in an automated fashion using continuous deployment best practices. This architectural approach not only bolsters system robustness but also significantly enhances its capacity to manage and adapt to varying operational demands.

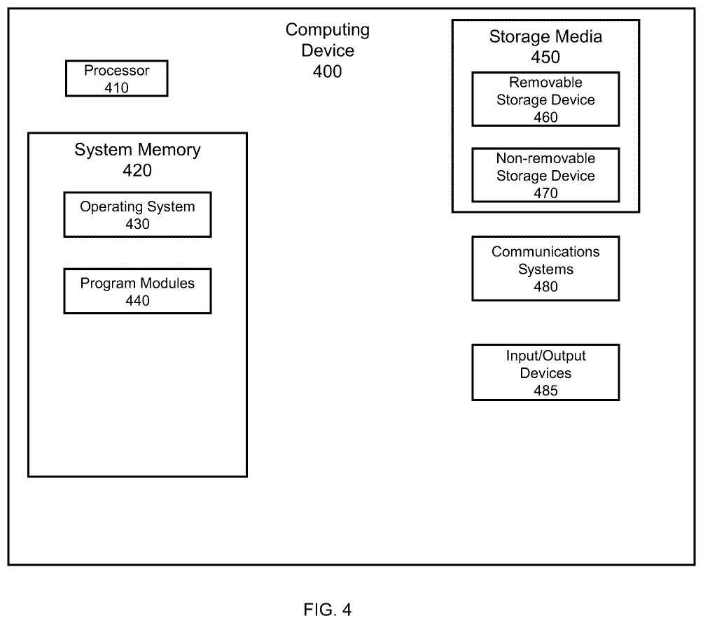

FIG. 4 is a block diagram illustrating physical components (e.g., hardware) of a computing device 400 with which aspects of the disclosure may be practiced. The computing device 400 may be integrated or otherwise associated with any of the various systems described above with respect to FIGS. 1-3B. For example, the computing device 400 may be integrated or otherwise associated with the data acquisition module 18, the model training module 20, the dynamic course generation module 22, the content integrity verification module 24, the learning management system bridge 26, the database 28, the verified source 32, the vetted database 34, the adaptive learning orchestrator 36, and/or the personalization module 38.

In a basic configuration, the computing device 400 may include at least one processor 410 and a system memory 420. Depending on the configuration and type of computing device, the system memory 420 may comprise, but is not limited to, volatile storage (e.g., random access memory), non-volatile storage (e.g., read-only memory), flash memory, or any combination of such memories. The system memory 420 may include an operating system 430 and one or more program modules 440 or components suitable for performing the various operations described above. The operating system 430 may be suitable for controlling the operation of the computing device 400.

The computing device 400 may have additional features or functionality. For example, the computing device 400 may also include additional data storage media 450 which may comprise devices (removable and/or non-removable) such as, for example, magnetic disks, optical disks, or tape. Such additional storage is illustrated in FIG. 4 by a removable storage device 460 and a non-removable storage device 470.

As stated above, a number of program modules 440 and data files may be stored in the system memory 420. While executing on the processing unit 410, the program modules 440 may perform the various processes including, but not limited to, the aspects of a personalized learning and adaptive simulation engine, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 400 on the single integrated circuit (chip). Examples of the disclosure may also be practiced using other technologies capable of performing logical operations such as, for example, “AND”, “OR”, and “NOT”, including but not limited to mechanical, optical, fluidic, and quantum technologies. In addition, examples of the disclosure may be practiced within a general-purpose computer or in any other circuits or systems.

The computing device 400 may also have one or more input/output device(s) 485. These include, but are not limited to, a keyboard, a trackpad, a mouse, a pen, a sound or voice input device, a touch, force and/or swipe input device, a display, speakers, a printer, sensors (which may include location sensors, accelerometers, position sensors, capacitive touch sensors, the like), etc. The aforementioned devices are examples and others may be used. The computing device 400 may include one or more communication systems 480 that allow or otherwise enable the computing device 400 to communicate with remote computing devices. Examples of suitable communication connections include, but are not limited to, radio frequency (RF) transmitter, receiver, and/or transceiver circuitry; universal serial bus (USB), parallel, and/or serial ports. Communication systems may also comprise physical ports (i.e., ethernet or fiber optic) or wireless antenna and supporting hardware which enable the computing device 400 to send or receive data over an internet connection.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage device 460, and the non-removable storage device 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

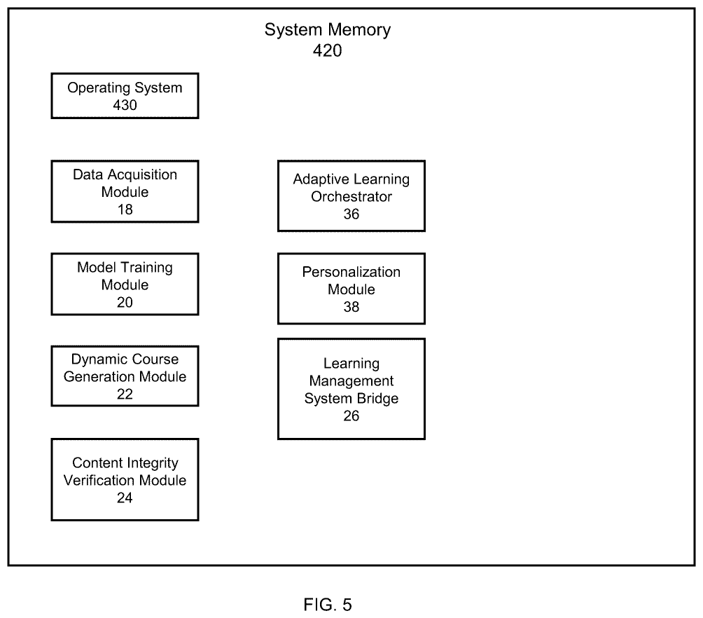

FIG. 5 is a block diagram of system memory 420 incorporating example aspects of a personalized learning and adaptive simulation engine. The implementation includes an operating system 430, a data acquisition module 18, a model training module 20, a dynamic course generation module 22, a content integrity verification module 24, a learning management system bridge 26, an adaptive learning orchestrator 36, and a personalization module 38.

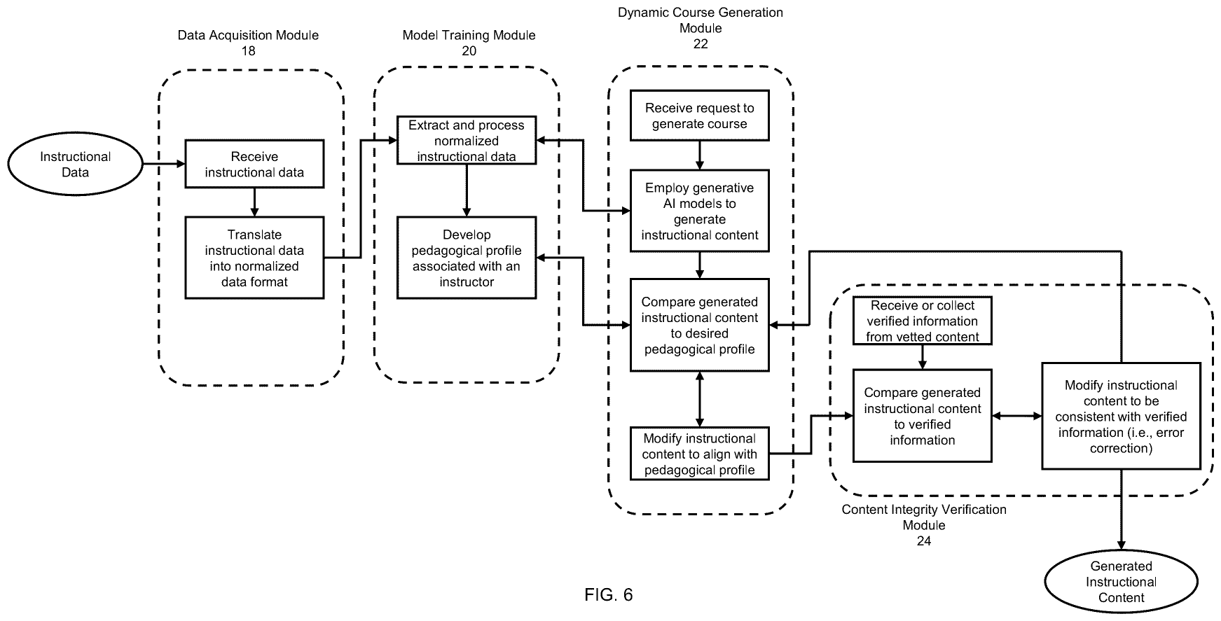

FIG. 6 is a flowchart of an implementation of aspects of a personalized learning and adaptive simulation engine.

The implementation includes a data acquisition module 18, a model training module 20, a dynamic course generation module 22, and a content integrity verification module 24. The modules 18, 20, 22, and 24 may be stored within a system memory of a computing device such as the system member 420 of the computing device 400 shown in FIG. 4. The modules 18, 20, 22, and 24 are configured to cause a processor such as the processor 410 of the computing device 400 shown in FIG. 4 to perform steps of the adaptive simulation engine 10 shown in FIGS. 1 and 2.

The data acquisition module 18 within the system memory of a computing device receives or retrieves, when implemented on the processor, instructional data. The data acquisition module 18 retrieves instructional data from storage media within the same computing device such as the storage media 450 of computing device 400 shown in FIG. 4. The data acquisition module 18 may also retrieve instructional data from one or more external computing devices (for example, a cloud server hosting a database of educational texts) via the communication systems of the computing device on which the data acquisition module 18 is implemented. The data acquisition module 18 may receive instructional data via the input/output devices or communications systems of the computing device on which the data acquisition module 18 is implemented.

The data acquisition module, when implemented on the processor, translates the received instructional data into a normalized format.

A model training module 20 within the system memory of a computing device, when implemented on the processor, extracts and processes the normalized instructional data.

The model training module 20 receives normalized instructional data from the data acquisition module 18 and extracts instructional data from the received data. In some implementations, the model training module 20 retrieves data from one or more databases (which may be located on the same computing device or accessed on a remote computing device via communications systems of the computing device on which the model training module is implemented). The model training module 20 categorizes the extracted instructional data by subject matter—for example the model training module separates extracted instructional data regarding the subject “English” from the subject “Math.” The model training module further sub-categorizes instructional data—for example, within the subject of “Math” the model training module may separate instructional data into the sub-categories of “Algebra” and “Trigonometry.” The model training module sub-sub-categorizes instructional data as applicable based on subject matter or topic. The model training module sub-categorizes and cross-categorizes instructional data based on a variety of factors. Cross-categorization refers to associating a fact or information point with two or more applicable topics or subject matter areas. For example, instructional data regarding of taking the derivative of a function may be cross-categorized into the “Calculus” sub-topic of “Math” and the “Kinematics” sub-sub-category of the “Mechanics” sub-category of the topic “Physics.”

The model training module 20 processes instructional data to develop a pedagogical profile based on an instructor. For example, the pedagogical profile reflects pedagogical approaches employed by the instructor. The pedagogical profile may reflect the mannerisms, traits, or other qualitative characteristics of the instructor, such as language usage, tone of voice, and personality.

The dynamic course generation module 22 within the system memory of a computing device, when implemented on the processor, receives instructions to develop a course or course materials based on the input of the instructor and/or learner to a computing device. Consistent with the course specification and objectives 115 as shown in FIGS. 3A-3B, these instructions specify the course's subject matter, desired structure, learning outcomes, and objectives.

The instructions are based, for example, on a request received via the input/output devices of the computing device 400 shown in FIG. 4. In other implementations, the instructions are based on a request received from external computing devices via the communication systems of the computing device (for example, an instructor submits the request on their smartphone and the dynamic course generation module is implemented on the processor of a cloud server). The dynamic course generation module receives signals from the input/output devices and/or the communication systems transmitting the request and the dynamic course generation module translates the signals into the instructions.

The dynamic course generation module employs one or more generative artificial intelligence models to generate instructional content. For example, the dynamic course generation module employs one or more generative artificial models to create text, image or graphic, audio, video, or other content, or combinations of any two or more content formats, corresponding to the course specification and objectives. The dynamic course generation module 22 retrieves or receives data from the model training module 20 and/or one or more databases 28 as shown in FIGS. 1-2 and utilizes such data in the generation of instructional content.

The dynamic course generation module 22 compares the generated instructional content with the pedagogical profile of an instructor retrieved or received from the model generation module 20. For example, the dynamic course generation module compares the generated instructional content against qualitative elements of the pedagogical profile (i.e., the dynamic course generation module compares whether the generated content reflects the speech patterns, tone of voice, pitch, use of language and phrasing of a given instructor when compared to samples of the instructor's speech). In addition or alternatively, the dynamic course generation module compares the generated instructional content against quantitative elements of the pedagogical profile (i.e., whether the content and course use the same instructional theory as the given instructor).

If the generated instructional content is inconsistent with the pedagogical profile, the dynamic course generation module modifies the generated instructional content to more closely align with the pedagogical profile. Generated instructional content is considered to align with the pedagogical profile when the generated instructional content matches one or more quantitative or qualitative features of the pedagogical profile.

For example, the pedagogical profile indicates that the instructor has a practice of utilizing visual aids in the form of graphs to present information. In this example, the dynamic course generation module 22 modifies the generated instructional content by causing the AI model to convert the generated instructional content from a non-graph to graph display format and/or generate additional instructional content in the form of graphs consistent with the subject matter and content of the original generated instructional content.

In another example, the pedagogical profile indicates that the instructor has a practice of utilizing intermediary check-ins to verify the learner has acquired or mastered the presented material. In this example, the dynamic course generation module 22 modifies the generated instructional content by identifying points in the generated instructional content suitable for performing a check of the learner's comprehension and causing the AI model to generate additional instructional content in the form of questions to evaluate learner comprehension consistent with the subject matter and content of the original generated instructional content.

In some implementations the functions of the dynamic course generation module 22 may be performed iteratively, meaning that instructional materials are generated, compared with the pedagogical profile, modified, compared with the pedagogical profile again, modified again, and so forth. In some implementations the dynamic course generation module may generate additional instructional materials if the first generated instructional content cannot be modified to align with the pedagogical profile.

A content integrity verification module 24 within the system memory of a computing device, when implemented on the processor, retrieves or collects verified information from vetted sources. Verified information may be received from storage media within the same computing device. Verified information may also be received from one or more external computing devices (for example, a cloud server hosting a database of educational texts) via the communication systems of the computing device. Verified information means that the accuracy and truthfulness of the information has been reviewed and confirmed by at least one recognized source. A vetted source is a known source that has been previously examined for accuracy and truthfulness. In some implementations, vetted sources for reference are identified by the instructor.

The content integrity verification module 24 compares the generated instructional content to the verified information and identifies inconsistencies between the generated instructional content and verified information. For example, the content integrity verification module extracts key points or facts from the generated instructional content and the verified information and compares the key points or facts from the generated instructional content to the key points or facts from the verified information. The content integrity verification module labels the key points or facts from the generated instructional content that are not found in the verified information as fabricated information.

The content integrity verification module corrects errors in the generated instructional content, i.e., to modify the generated instructional content to remove inconsistencies with the verified information. For example, the content integrity verification module removes the fabricated information from the generated instructional content. Further, the content integrity verification module replaces the fabricated information with associated key points or facts from the verified information. As a result, the content integrity verification module ensures that the generated instructional content is accurate and reduces fabrications generated by the dynamic course generation module's use of artificial intelligence models.

In some implementations the functions of the content integrity verification module may be performed iteratively, meaning that instructional materials are compared with the verified information, modified, compared with the verified information again, modified again, and so forth.

In some implementations, an iterative approach may be employed where content is generated, compared and modified to fit a pedagogical profile, compared and modified to correct errors against verified information, compared again against a pedagogical profile and modified to align with the pedagogical profile, compared and modified to correct errors against verified information, and so forth. In some implementations the dynamic course generation module may generate additional instructional materials if the first generated instructional content cannot satisfactorily complete all processes.

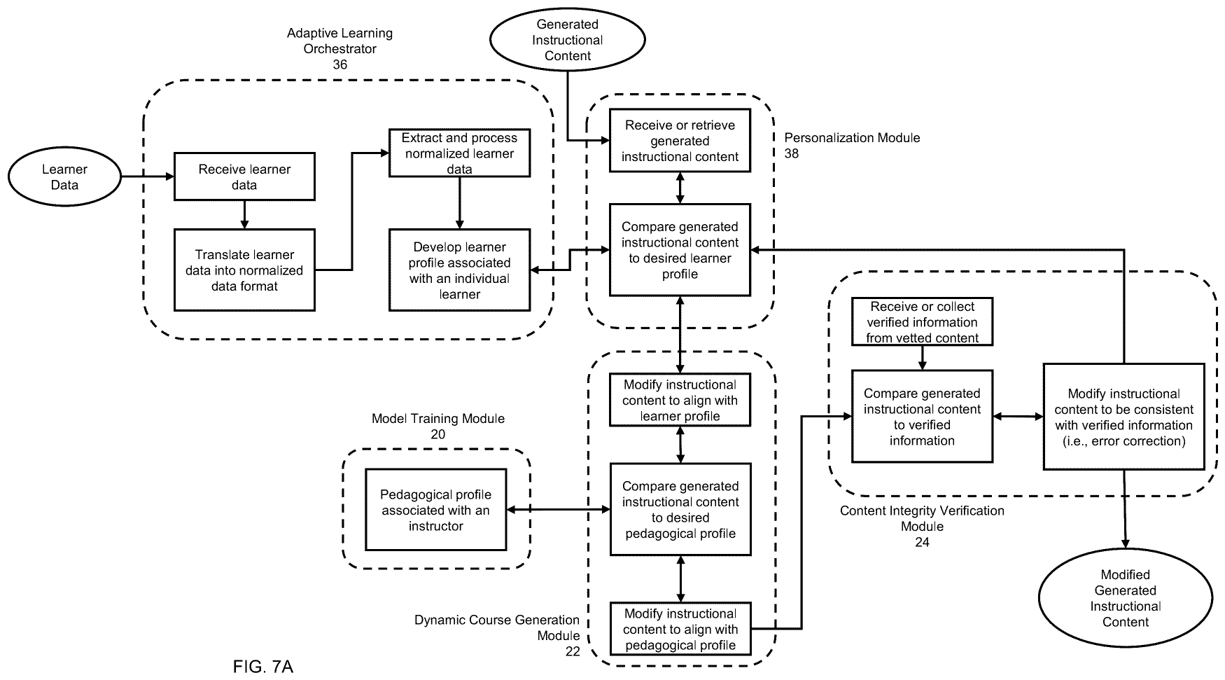

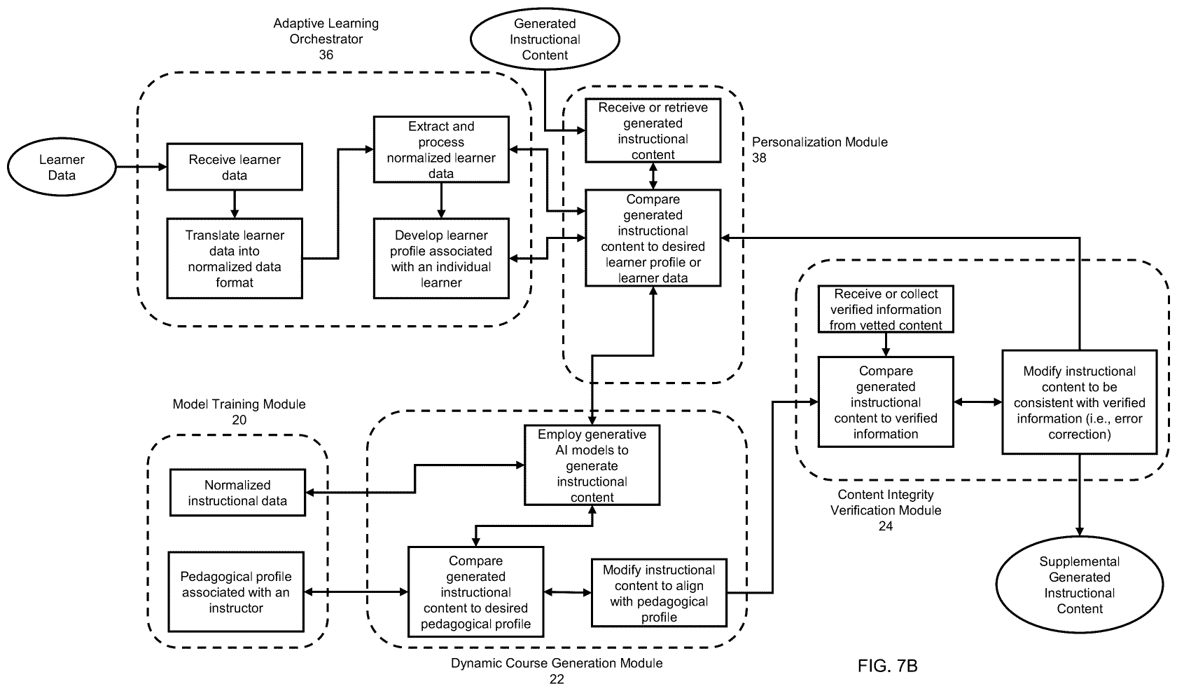

FIG. 7A is a flowchart of an implementation of aspects of a personalized learning and adaptive simulation engine.

The implementation includes a model training module 20, a dynamic course generation module 22, a content integrity verification module 24, an adaptive learning orchestrator 36, and a personalization module 38. The modules 20, 22, 24, 36, and 38 may be stored within a system memory of a computing device such as the system member 420 of the computing device 400 shown in FIG. 4. The modules 20, 22, 24, 36, and 38 are configured to cause a processor such as the processor 410 of the computing device 400 shown in FIG. 4 to perform steps of the adaptive simulation engine 10 shown in FIGS. 1 and 2.

The adaptive learning orchestrator 36 retrieves or receives learner data from one or more sources which may include a database, storage media, external computing devices, and/or the learner via the input/output devices of a computing device and data acquisition module.

The adaptive learning orchestrator 36 converts the received or retrieved learner data into a normalized format. The adaptive learning orchestrator 36 extracts and processes learner data. This processing includes identifying current learner knowledge, capturing learner objectives, evaluating learner performance on assessments provided to the learner, synthesizing qualitative and quantitative learner preferences for educational content, and synthesizing instructional preferences or formats which are more effective for the learner. From this extracted and processed learner data, the adaptive learning orchestrator 36 develops a learner profile associated with the learner.

The personalization module 38 receives or retrieves generated instructional content from one or more sources which may include a database, storage media, external computing devices, or the dynamic course creation module (as shown in FIG. 2).

The personalization module 38 compares the generated instructional content with the learner profile received or retrieved from the adaptive learning orchestrator 36. The personalization module 38 identifies inconsistencies between the generated instructional content and the learner profile and develops proposed modifications to address the inconsistencies. The personalization module 38 instructs the dynamic course generation module 22 to employ one or more AI models to facilitate the modifications.

In an example, the personalization module 38 receives generated instructional content covering basic Spanish language from a database storing previously generated instructional content. The personalization module 38 receives a learner profile from the adaptive learning orchestrator 36 indicating that the learner has taken an assessment and demonstrated competence in Spanish language equivalent to having completed one year of traditional university study. The personalization module 38 identifies that the generated instructional content includes content which would be redundant to the learner based on the learner's skill level. The personalization module 38 instructs the dynamic course generation module 22 to modify the generated instructional content by removing or omitting the content identified as redundant. The dynamic course generation module 22 employs one or more AI models to remove the identified redundant content and insert transitions between the remaining content such that the modified generated instructional content flows coherently (i.e. it is not obvious to the learner that content was removed).

In another example, the personalization module 38 receives generated instructional content comprising an AI instructor giving an oral lecture on a topic from the dynamic course generation module. The personalization module also receives a learner profile from a database containing a stored learner profile indicating that the learner responds more favorably to instructional activities involving frequent learner input and interaction. The personalization module 38 identifies that the generated instructional content comprising a lecture is inconsistent with the learner's preferred learning style. The personalization module 38 instructs the dynamic course generation module 22 to modify the generated instructional content by changing the lecture format to a Socratic method format (i.e., using the teaching technique of the instructor asking a series of questions to engage the learner in the process). The dynamic course generation module 22 employs one or more AI models to reconfigure the generated instructional content to be presented in this style.

As discussed in relation to FIG. 6, the dynamic course generation module 22 compares the modified generated instructional content to a pedagogical profile received from the model training module 20, and further modifies the modified generated instructional content to align with the pedagogical profile.

As discussed in relation to FIG. 6, the content integrity verification module 24 compares the modified generated instructional content to one or more vetted sources and further modifies the modified generated instructional content to correct fabrications, inaccuracies, or similar errors in the modified generated instructional content.

In some implementations, an iterative approach may be employed where content is generated, compared and modified to fit a pedagogical profile, compared and modified to correct errors against verified information, compared and modified to fit a learner profile, compared again against the pedagogical profile and modified to align with the pedagogical profile, compared and modified to correct errors against verified information, compared again against the learner profile and modified to align with the learner profile, and so forth.

FIG. 7B is a flowchart of an implementation of aspects of a personalized learning and adaptive simulation engine.

The implementation includes a model training module 20, a dynamic course generation module 22, a content integrity verification module 24, an adaptive learning orchestrator 36, and a personalization module 38. The modules 20, 22, 24, 36, and 38 may be stored within a system memory of a computing device such as the system member 420 of the computing device 400 shown in FIG. 4. The modules 20, 22, 24, 36, and 38 are configured to cause a processor such as the processor 410 of the computing device 400 shown in FIG. 4 to perform steps of the adaptive simulation engine 10 shown in FIGS. 1 and 2.

The modules 20, 22, 24, 36, and 38 perform functions as described in relation to FIG. 7A.

The adaptive learning orchestrator 36 receives learner data comprising a question, query, or request from a learner via the learner's use of the input/output devices of a computing device.

The personalization module 38 compares generated instructional content received from one or more sources with learner data received or retrieved from the adaptive learning orchestrator 36. In some circumstances, the personalization module 38 identifies inconsistencies or gaps (i.e. absent or non-responsive information) between the generated instruction content and the learner data and/or learner profile. In these circumstances, the personalization module 38 directs the dynamic course generation module 22 to employ AI model(s) to generate supplemental generated instructional content responsive to the learner data and/or learner profile.

In an example, a learner inputs a question “what caused the 1929 stock market crash?” via input/output devices of a computing device as shown in FIG. 4. The adaptive learning orchestrator 36 receives this input query as learner data and transmits this data to the personalization module 38. The personalization module 38 receives generated instructional content from a database of previously generated instructional content on the history of the Great Depression. The personalization module 38 compares the generated instructional content to the learner query and identifies that there is no generated instructional content responsive to the learner's query. The personalization module 38 instructs the dynamic course generation module 22 to generate supplemental instructional materials responsive to the query. The dynamic course generation module 22 employs one or more AI models to generate the supplemental instructional materials. The dynamic course generation module 22 retrieves data from one or more sources, which may include model training module 20, databases, storage media, and/or external computing devices for use by the AI model in generating the supplemental instruction materials.

In some implementations, an iterative approach may be employed where supplemental instructional content is generated, compared and modified to fit a pedagogical profile, compared and modified to correct errors against verified information, compared and modified to fit a learner profile, compared again against the pedagogical profile and modified to align with the pedagogical profile, compared and modified to correct errors against verified information, compared again against the learner profile and modified to align with the learner profile, and so forth.

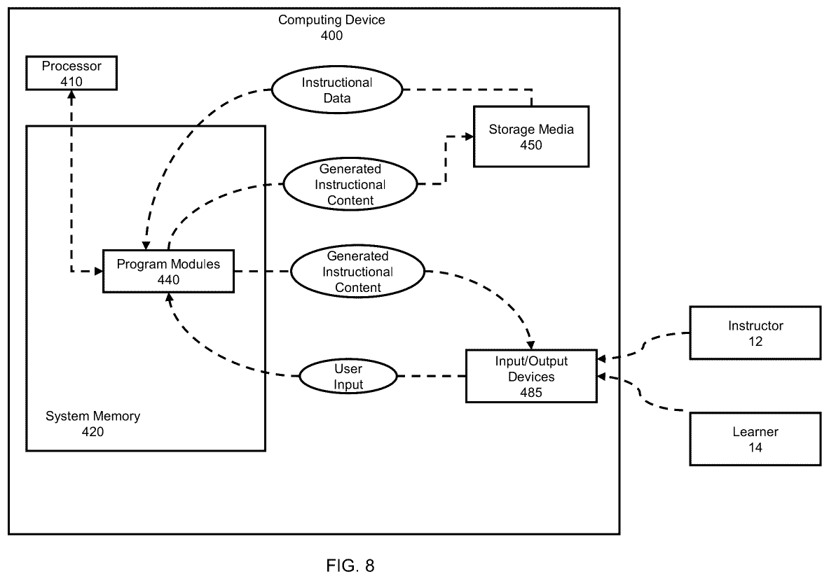

FIG. 8 is a block diagram showing the flow of information between components of a computing device 400 according to aspects of a personalized learning and adaptive simulation engine.

In FIG. 8, program modules 440 refer to any one or more of the modules disclosed herein, including data acquisition module 18, model training module 20, dynamic course generation module 22, content integrity verification module 24, learning management system bridge 26, adaptive learning orchestrator 36, and/or personalization module 38.

Program modules 440 are executed by processor 410.

Instructor 12 and/or learner 14 interact with input/output devices 485 of the computing device 400 (for example, by typing in a question in natural language). This user input is transmitted from the input/output devices 485 to the program modules 440 within system memory 420 of the computing device 400. User input comprises any type of data and may specifically comprise instructional data, learner data, other data, or any combination thereof.

Program modules 440 retrieve or receive instructional data from storage media 450 of the computing device 400. Program modules 440 generate generated instructional content according to the systems and methods described above. Program modules 440 transmit the generated instructional content to the input/output devices 485 for output to the instructor 12 and/or learner 14. Program modules 440 transmit the generated instructional content to storage media 450 for storage and future use.

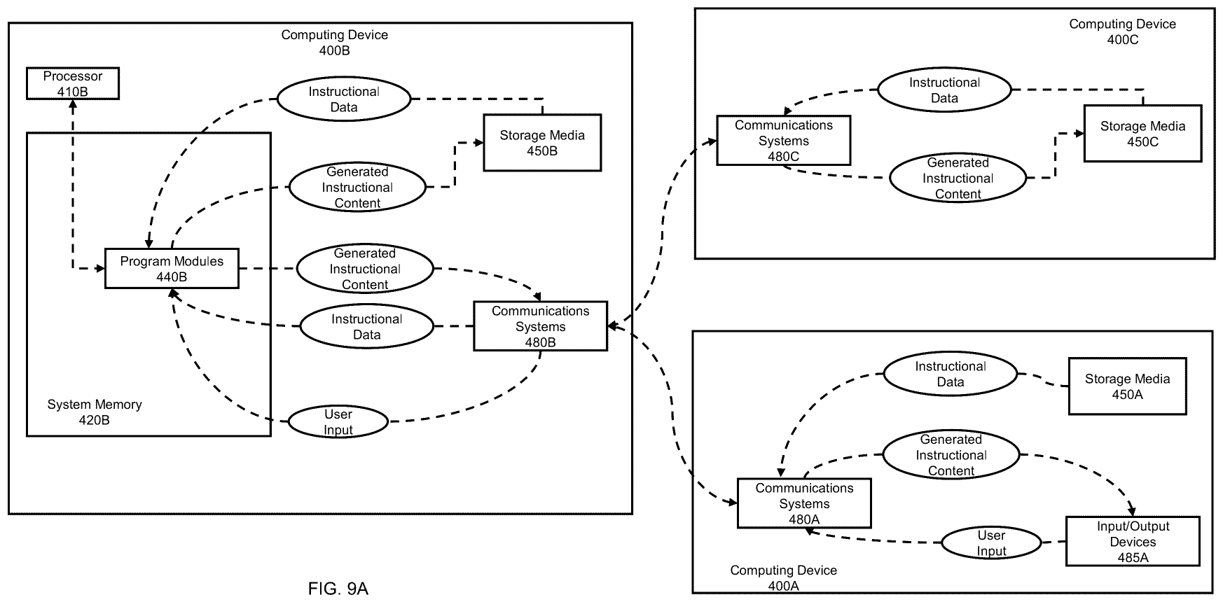

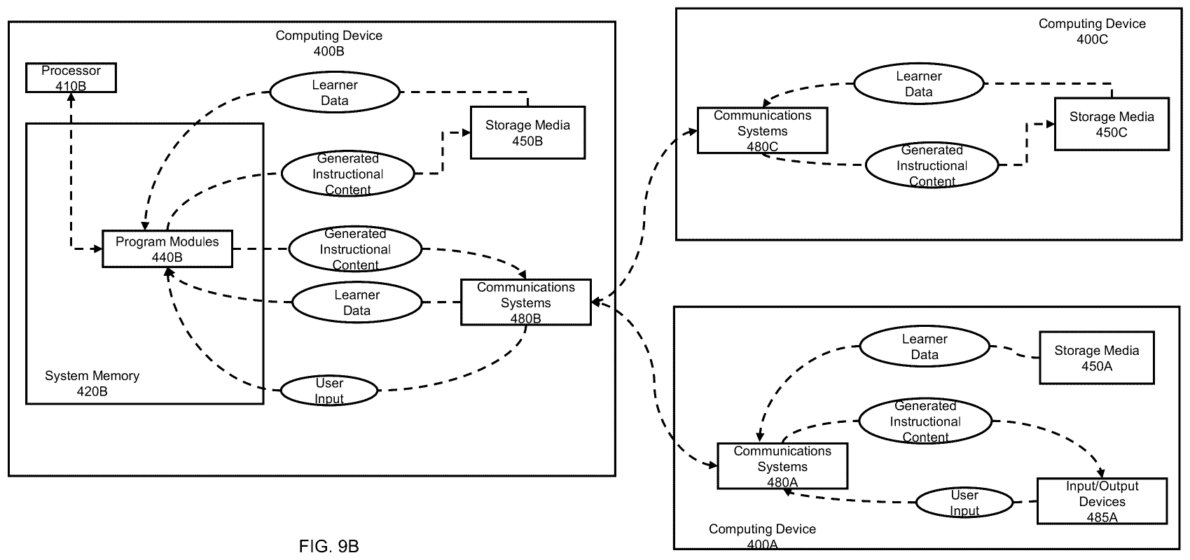

FIG. 9A is a block diagram showing the flow of information between multiple computing devices 400A-C and components thereof according to aspects of a personalized learning and adaptive simulation engine.

In some implementations a personalized learning and adaptive simulation engine involves more than one computing device 400. Computing devices 400A-C interface with each other and share information via communications systems 480 of each respective computing device 400.

Instructor 12 (not shown in FIG. 9A) interacts with input/output devices 485A of the computing device 400A. User input resulting from this interaction is transmitted from input/output devices 485A to communications systems 480A of computing device 400A. Instructional data from storage media 450A of computing device 400A is transmitted to communications systems 480A of computing device 400A.

User input and instructional data are transmitted from communications systems 480A to communication systems 480B of computing device 400B. The received user input and instructional data is transmitted from the communications systems 480B to the program modules 440B within the system memory 420B of computing device 400B.

Program modules 440B retrieve or receive instructional data from storage media 450B of computing device 400B. Instructional data from storage media 450C of computing device 400C is transmitted to communications systems 480C of computing device 400C. Instructional data are transmitted from communications systems 480C to communication systems 480B of computing device 400B. In this way, program modules 440B retrieve or receive data from storage media 450C of computing device 400C. For example, this occurs when program modules are executed on a first computing device but retrieve instructional data from a second computing device, such as a cloud storage server hosting instructional databases.

The program modules 440B are executed by processor 410B of computing device 400B resulting in the creation of generated instructional content. Generated instructional content is transmitted from program modules 440B to storage media 450B of computing device 400B. Generated instructional content is transmitted from program modules 440B to communications systems 480B of computing device 400B.

Generated instructional content is transmitted from communications systems 480B of computing device 400B to communications systems 480C of computing device 400C. Generated instructional content is transmitted from communications systems 480C to storage media 450C of computing device 400C for storage and later use.

Generated instructional content is transmitted from communications systems 480B of computing device 400B to communications systems 480A of computing device 400A. Generated instructional content is transmitted from communications systems 480A to storage media 450A of computing device 400A for storage and later use. Generated instructional content is transmitted from communications systems 480A to input/output devices 485A of computing device 400A for output to the instructor and/or learner.

FIG. 9B is a block diagram showing the flow of information between multiple computing devices 400A-C and components thereof according to aspects of a personalized learning and adaptive simulation engine.

FIG. 9B illustrates similar flows of learner data to the flow of instructional data described in connection with FIG. 9A.

Implementations of a personalized learning and adaptive simulation may involve any number of computing devices, and not all steps or processes are limited to occurrence on any particular device.

This disclosure provides an innovative way to automate the labor-intensive and time-consuming process of course creation and personalized delivery by a tutor or instructor. By leveraging artificial intelligence and instructor samples, the system can produce comprehensive and personalized courses at scale, revolutionizing the field of online education.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense. Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Regardless of whether shown and described in combination or separately, the various features (both structural and methodological) are intended to be selectively included or omitted to produce an embodiment with a particular set of features. In addition, each of the operations described above may be executed in any order. For example, one operation may be performed before another operation. Additionally, one or more of the disclosed operations may be performed simultaneously or substantially simultaneously.

What is claimed is:

1. An educational computing device for generating personalized instructional content, the educational computing device including a system memory and a processor in communication with the system memory, the system memory comprising:
a data acquisition module that causes the processor to:
collect instructional data associated with an instructor; and
translate the instructional data into a normalized computer-readable format;
a model training module that causes the processor to:
receive the instructional data in the selected format from the data acquisition module;
extract multi-modal features from the data; and
identify a pedagogical pattern from the multi-modal features extracted from the data, wherein the pedagogical pattern is associated with the instructor;
a dynamic course generation module that causes the processor to:
employ one or more generative artificial intelligence models to generate instructional materials based on the pedagogical pattern associated with the instructor; and
translate the generated instructional materials into a format capable of display to an individual learner; and
a content integrity verification module that causes the processor to:
collect verified information on the subject matter of the generated instruction material, wherein the verified information comprises information from one or more databases of vetted content;
compare the verified information with the generated instruction materials;
identify differences between the verified information and the generated instruction materials; and
modify portions of the generated instruction materials which are inconsistent with the verified information such that the modified portions of the generated instruction materials are consistent with the verified information;
wherein the dynamic course generation module causes the processor to output a personalized instructional course including the updated generated instructional materials in the format capable of display to an individual learner.

2. The educational computing device of claim 1, where the system memory of the computing device further comprises:
an adaptive learning orchestrator that causes the processor to:
collect learner data from one or more inputs regarding an individual learner's interaction with the system;
extract multi-modal learner features from the learner data; and
identify an individual learner pattern from the multi-modal learner features extracted from the learner data, wherein the individual learner pattern is associated with the individual learner; and
a personalization module configured to:
employ one or more of the generative artificial intelligence models to at least one of generate supplemental instruction materials or modify the generated instructional materials based on the individual learner pattern; and
translate the modified or supplemental generated instructional materials into a format capable of display to an individual learner.

3. The educational computing device of claim 1, where the system memory of the computing device further comprises:
an adaptive learning orchestrator that causes the processor to:
collect learner data from one or more inputs regarding an individual learner's interaction with the system;
extract multi-modal learner features from the learner data;
identify an individual learner pattern from the multi-modal learner features extracted from the learner data, wherein the individual learner pattern is associated with the individual learner; and
provide the individual learner pattern to the dynamic course generation module; and
wherein the dynamic course generation module causes the processor to:
employ one or more of the generative artificial intelligence models to create the generated instructional materials based on the individual learner pattern.

4. The educational computing device of claim 1, where the system memory of the computing device further comprises a learning management system integrator that causes the processor to:
receive a set of content parameters from a learning management software application;
compare the generated instructional materials to the provided content parameters;
modify the generated instructional materials based on the provided content parameters; and
communicate the instructional materials generated by the system to the learning management software application without manual intervention.

5. A computer-implemented method for generating and delivering personalized instructional content, the computer implemented method implemented by an educational computing device including a system memory and a processor in communication with the system memory, the computer-implemented method comprising:
collecting via a data acquisition module instructional data from one or more data sources;
processing via the data acquisition module the instructional data into a normalized computer-readable format;
storing the processed instructional data on an electronic data storage media;
developing via a model training module a pedagogical pattern associated with an instructor based on the stored instructional data;
employing via the dynamic course generator one or more generative artificial intelligence models to create instructional materials based on the pedagogical pattern associated with the instructor;
comparing via a verifier the generated instructional materials against verified information sources;
modifying, via the verifier, the generated instructional materials to align with the verified information based on the comparison of the generated instructional materials against verified information sources; and
causing a processor to output a personalized instructional course including the generated instructional materials in a format capable of display to an individual learner.

6. The method of claim 5 further comprising:
collecting, via the data acquisition module, data regarding an individual learner's interaction with a computer educational system;
translating, via the data acquisition module, the data regarding the individual learner's interaction with the computer educational system into a normalized computer-readable format;
storing the processed individual learner data on the electronic data storage media of the computing device;
developing, via the model training module, an individual learner pattern associated with a particular instructor based on the stored individual learner data;
employing via the dynamic course generator one or more generative artificial intelligence models to create or modify instructional materials based on the individual learner pattern.

7. The method of claim 6, further comprising
receiving via a learning management system integrator a set of content parameters from a learning management software application;
modifying, via the learning management system integrator, instructional materials generated by the method to comply with the provided content parameters; and
communicating via the learning management system integrator the instructional materials generated by the method to the learning management software application as such instructional materials are created.

8. The system of claim 1, where the system memory of the computing device further comprises a normalizer that causes the processor to
detect inconsistencies in the format of the instructional data; and
translate instructional data not in a first format into the first format.

9. The system of claim 1 where the model training module utilizes transformer-based neural network architecture to develop an instructor profile.

10. The system of claim 1 where the dynamic course generator further causes the processor to:
receive data regarding the comparative effectiveness of two or more formats of instructional materials; and
select from among the generated instructional materials the materials only those materials in the format having the highest comparative effectiveness.

11. The educational computing device of claim 2, where the adaptive learning orchestrator causes the processor to:
collect an individual learner's input of natural language; and
employ one or more natural language processing algorithms to extract learner data from the natural language input.

12. The system of claim 2 where the adaptive learning orchestrator further causes the processor to:
compare two or more formats of instructional materials with respect to an individual learner as part of the individual learner pattern to criteria;
select one of the two or more formats based on the comparison; and
modify the generated instructional materials into the selected format.

13. The system of claim 12, where the adaptive learning orchestrator utilizes a multi-armed bandit algorithm to select the instructional material format based on the comparison of the two or more formats to the criteria.

14. The system of claim 1, where the content integrity verification module further causes the processor to:
collect one or more educational content standards;
compare the generated instructional materials to the educational content standards;
identify whether the generated instructional materials comply with the educational content standards;
modify portions of the generated instruction materials which are inconsistent with the educational content standards such that the modified portions of the generated instruction materials are consistent with the educational content standards.
